(19) United States
(12) Patent Application Publication
(10) Pub. No.: US 2012/0200452 A1
(43) Pub. Date: Aug. 9, 2012

(54) METHOD AND APPARATUS FOR CALCULATING THE DISPLACEMENT AND VELOCITY OF IMPACT-DRIVEN PILES

(75) Inventor: William C. Jones, Overland Park, KS (US)

(73) Assignee: Piletrac, LLC, Overland Park, KS (US)

(21) Appl. No.: 13/023,308

(22) Filed: Feb. 8, 2011

(51) Int. Cl. G01S 13/42; G01C 3/08; G01S 13/88; G01S 13/58

(52) U.S. Cl. 342/109; 356/4.01

(57) ABSTRACT

A method and system are disclosed for calculating a longitudinal displacement and a velocity of the longitudinal displacement of a load bearing pile as the pile is being driven into the ground by blows delivered from a pile driver. A series of signals, such as electromagnetic waves at a frequency above 800 Hz and a wavelength less than 1 mm, are emitted from a signal emitter in a direction toward the pile as the pile is being driven along its longitudinal length into the soil. The series of signals are reflected off of a reflector mounted at a fixed position on the pile and are redirected toward a sensor that is positioned for receiving the reflected series of signals. The reflected series of signals received at said sensor and the preselected frequency at which the series of signals are emitted from said signal emitter are routed to a computing device where the longitudinal displacement of the pile and the velocity of the longitudinal displacement are calculated.

### BACKGROUND OF THE INVENTION

The present invention relates generally to piles that are driven into the ground to provide support for buildings and other structures and, more particularly, to methods and apparatus for calculating the longitudinal displacement and velocity of longitudinal displacement of such piles so that their load bearing capacity may be determined.

Piles are relatively long, slender columns, typically formed of steel, concrete or timber, which are driven into the ground by mechanical devices known as pile drivers. The piles are normally driven vertically or at a preselected angle of inclination to the ground surface to provide support for the foundation of buildings and other structures. Pile drivers typically have a heavy weight, referred to as a hammer or ram, which is repeatedly raised above the end of the pile and released so that it impacts against the end of the pile to drive it into the soil.

The load bearing capacity of a driven pile is limited either by the structural strength of the pile itself or by the load carrying capacity of the ground supporting the pile. The structural strength of the pile is determined by the selection of the size, shape and material used for the pile. Common materials used for the pile are steel, concrete and timber. The capacity of the ground varies widely by local ground conditions and is normally determined by testing of the pile during or after it has been driven into the soil. In dynamic testing of the pile as it is being driven into the soil, it is necessary to measure the distance the pile moves longitudinally in response to a blow from the pile driver ram. This measured distance, also known as the pile set per blow, is then input with other measured parameters into any of various mathematical formulas to allow calculation of the load bearing capacity of the pile when driven into the soil.

Conventional measurement of the pile displacement or pile set per blow is an inherently dangerous task when performed by manually marking the pile. Normally, an individual is positioned within a few feet of the pile to mark a reference line on the pile after each blow from the pile driver ram. The massive weight of the ram repetitively impacting the pile can dislodge bolts and other fasteners from the pile driving leads, cause separation of pneumatic lines, and can fracture portions of the pile itself. There have even been instances where the ram has separated from the pile driver and plunged to the ground. These falling objects can strike and seriously injure the individual marking the displacement of the pile and anyone else positioned in close proximity to the pile.

Instead of determining pile displacement by manually marking reference lines on the pile, accelerometers and strain gauge transducers mounted on the pile have been used to calculate the pile longitudinal displacement as well as the velocity of the longitudinal displacement. The measured data from these instruments is fed to a computer which determines pile displacement by a double integration calculation and pile velocity by a single integration calculation. While the accelerometers and strain gauges eliminate the need for manual marking of the pile, the pile displacement and velocity calculated from the data measured by these instruments may be less accurate than desired, leading to less reliable calculation of the load bearing capacity of the driven pile. In addition, these instruments are sensitive and must be periodically recalibrated or replaced as they are prone to being damaged under the conditions in which they are used.

It is also known to calculate pile displacement by using a laser range finder positioned below or at an angle to a reflective target fixed to the pile. While the laser ranger finder can provide a reliable determination of the longitudinal displacement of the pile without the safety risks associated with manual measurement of the displacement, it is not known to have been used to determine the velocity of the longitudinal displacement of the pile.

A need thus exists for a reliable and safe method of measuring pile displacement and calculating pile velocity so that the load bearing capacity of a driven pile may be more readily and accurately determined.

### SUMMARY OF THE INVENTION

In one embodiment, the present invention is directed to a method of calculating a longitudinal displacement and a velocity of the longitudinal displacement of a load bearing pile as the pile is being driven into the soil. The method comprises the steps of emitting a series of signals at a preselected frequency from a signal emitter in a direction toward the pile as the pile is being driven longitudinally into the soil, reflecting the series of signals from a reflector coupled with said pile toward a sensor positioned for receiving the reflected series of signals, receiving the reflected series of signals at said sensor, and calculating the longitudinal displacement and the velocity of the longitudinal displacement of the pile using the reflected series of signals received at said sensor and the preselected frequency at which the series of signals are emitted from the signal emitter.

The signals can be in the form of electromagnetic or mechanical waves that are emitted at a frequency and wavelength that allow calculation of the longitudinal displacement and velocity to the desired degree of accuracy. In general, a frequency above 800 Hz and, more preferably, above 1200 Hz, and even more preferably, above 1800 Hz and a wavelength less than 2 mm and, more preferably, less than 1 min are desired. The calculation of the longitudinal displacement and velocity is performed using any suitable computing device operably coupled with the signal emitter and the sensor.

In another embodiment, the invention is directed to a system for calculating a longitudinal displacement and a velocity of the longitudinal displacement of a load bearing pile as the pile is being driven into the soil. The system comprises a signal emitter for emitting a series of signals at a preselected frequency in a direction toward the pile as the pile is being driven longitudinally into the soil, a reflector mounted at a fixed position on said pile for reflecting the series of signals from the signal emitter, a sensor positioned for receiving the reflected series of signals, and a computing device operably coupled with the signal emitter and the sensor for calculating the longitudinal displacement and the velocity of said longitudinal displacement of the pile using the reflected series of signals received at the sensor and the preselected frequency at which the series of signals are emitted from the signal emitter. The signal emitter is operable to emit a series of electromagnetic waves at a frequency above 800 Hz and, more preferably, above 1200 Hz, and even more preferably, above 1800 Hz with a wavelength less than 2 mm and, more preferably, less than 1 mm.

### BRIEF DESCRIPTION OF THE DRAWINGS

FIG. 1 is an elevation view of a system of the present invention for calculating the longitudinal displacement of a pile and the velocity of the longitudinal displacement as the pile is being driven into the ground.

### DETAILED DESCRIPTION

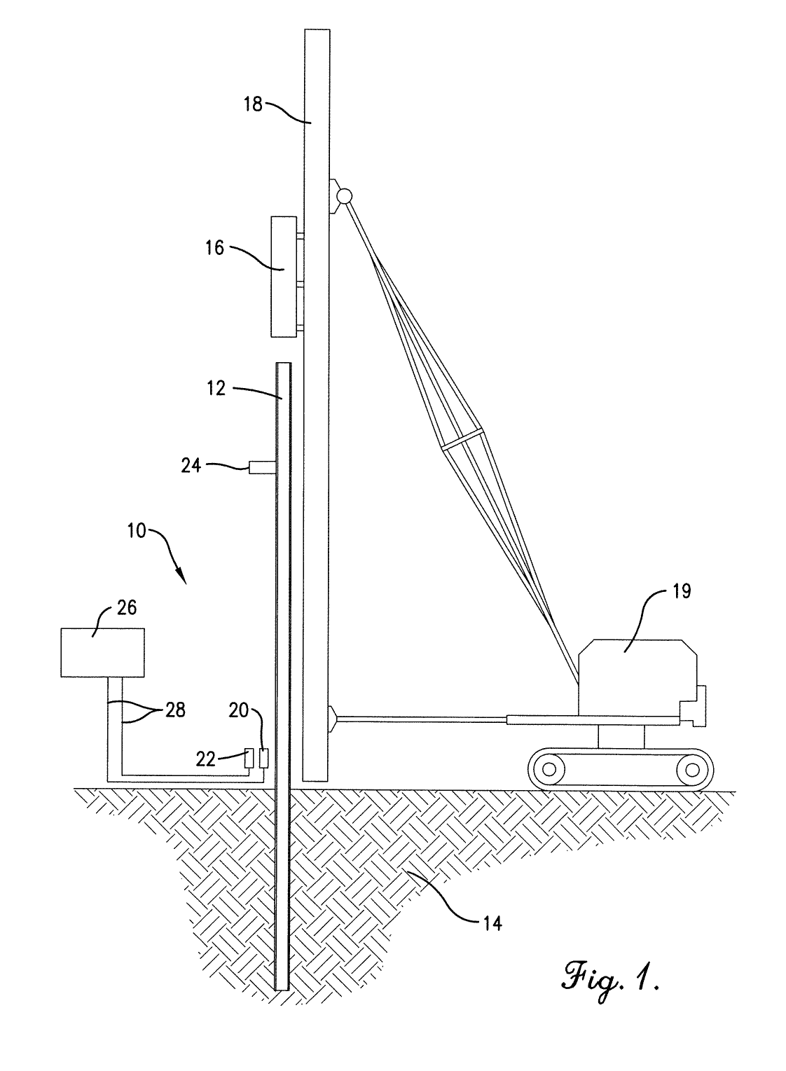

Turning now to FIG. 1 of the drawings, a system designated broadly by the numeral 10 is shown for calculating the longitudinal displacement and the velocity of the longitudinal displacement of a pile 12 as it is being driven into the ground 14 by repeated blows from a ram 16 of a pile driver 18 positioned by a crane 19. The system 10 comprises a signal emitter 20 of a type that is operable to emit a series of signals at a desired frequency and a sensor 22 that is sensitive to the signals emitted by the signal emitter 20. As an example, the signal emitter 20 may be any of various devices that are able to emit electromagnetic or mechanical waves at the desired frequency and wavelength and the sensor 22 is any of various devices that are sensitive to the specific electromagnetic or mechanical waves emitted by the signal emitter 20. In one embodiment, the signal emitter 20 and the sensor 22 are packaged together. In other embodiments, the signal emitter 20 and the sensor 22 are separable and may be remotely positioned in relation to each other. In one preferred embodiment, the signal emitter 20 and the sensor 22 comprise a laser range finder.

The system 10 also includes a reflector 24 that is mounted at a preselected fixed position in association with the pile 12. For example, the reflector 24 may be mounted on the pile itself, or on a structure associated with or mounted on the pile 12, such as an anvil that forms part of the pile driver 12. The reflector 24 includes a target surface that is capable of reflecting the signals from the signal emitter 20 to the sensor 22. For example, when the emitted signals are from a laser, the reflector 24 may include reflective tape or simply a light-colored surface that will reflect enough of the laser energy to allow the signal to reach the sensor 22.

The system 10 also includes a computing device 26 that is operably coupled with the signal emitter 20 and the sensor 22 and is capable of processing the data obtained from the signal emitter 20 and the sensor 22 to calculate the longitudinal displacement of the velocity of the longitudinal displacement of the pile 12 as the pile 12 is being driven into the ground 14. The computing device 26 is normally placed a preselected distance away from the pile 12 to allow the computing device 26 to be safely monitored.

The computing device 26 may be any one of a variety of devices including, but not limited to, personal computing devices, server-based computing devices, personal digital assistants, cellular telephones, other electronic devices having some type of memory, and the like. For ease of illustration and because it is not important for an understanding of the present invention, FIG. 1 does not show the typical components of many computing devices, such as a CPU, keyboard, a mouse, a printer, or other I/O devices, a display, etc.

The computing device 26 may be implemented in hardware, software, firmware, or a combination thereof and may include any number of processors, controllers, microprocessors, microcontrollers, programmable logic controllers (PLCs), field-programmable gate arrays (FPGAs), application specific integrated circuits (ASICs), or any other component or components that are operable to perform, or assist in the performance of, the operations disclosed herein.

The computing device 26 may also include memory elements for storing instructions or data. The memory elements may be a single component or may be a combination of components that provide the requisite functionality. The memory elements may include various types of volatile or non-volatile memory such as flash memory, optical discs, magnetic storage devices, SRAM, DRAM, or other memory devices capable of storing data and instructions. The memory elements may communicate directly with the computing device, or they may communicate with the computing device over a data bus or other mechanism.

The computing device 26 may implement one or more computer programs that perform functions described herein. The computer programs may comprise ordered listings of executable instructions for implementing logical functions in the computing device. The computer programs can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. A computer-readable medium can be any means that can contain, store, communicate, propagate or transport the program for use by or in connection with the instruction execution system, apparatus, or device. The computer-readable medium can be, for example, but not limited to, an electronic, magnetic, optical, electro-magnetic, infrared, or semi-conductor system, apparatus, device, or propagation medium. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

The signal emitter 20, sensor 22, and computing device 26 are operably coupled together by suitable cables 28 or by any of various wireless protocols. Power to operate these devices may be supplied by any suitable source of electricity, such as a battery, a solar or fuel-powered generator, or a connection to an electrical grid.

The pile 12 is elongated and has relatively long longitudinal length. The pile 12 can be of various cross-sectional configurations and is typically formed of steel, reinforced concrete or timber, but can be formed of other materials if desired. The pile driver 16 can be a diesel hammer, a hydraulic hammer, or any other suitable mechanical device capable of delivering repeated blows to an exposed end of the pile 12 to drive the pile 12 into the ground 14.

In operation, the system 10 is used for remotely calculating the longitudinal displacement of the pile 12 as it is being driven into the ground 14 by repeated blows from the ram 16 of the pile driver 18. The system 10 is also used for calculating the velocity of the longitudinal displacement of the pile 12 as it is being driven into the ground 14. The calculated longitudinal displacement and velocity are then used in any of various empirical formulas for calculating the static load bearing capacity of the driven pile 14.

The signal emitter 20 and sensor 22 are normally placed in close proximity to each other under the downward facing reflector 24 that is mounted to the pile 12 at the fixed position. Alternatively, the signal emitter 20 and sensor 22 may be positioned away from the pile 12 and/or spaced apart from each other. Tripods or other mounting devices may be used position the signal emitter 20 and sensor 22. The signal emitter 20 emits a series of signals, either continuously or discontinuously, in the vertical direction or at a preselected angle to the vertical direction toward the reflector 24. At least a portion of the emitted series of signals is reflected by the reflector 24 toward the sensor 22, which in turn transmits a signal correlated with the receipt of the reflected series of signals. The signal emitter 20 and sensor 22 communicate data to the computing device 26, which calculates and displays the longitudinal displacement of the pile 12 based on the changing time of flight of the signals as they travel from the signal emitter 20 to the sensor 22 or by other methodologies. A time stamp is associated with each longitudinal displacement reading so that the velocity of the longitudinal displacement of the pile 12 may be calculated by the computing device 26.

In order to obtain meaningful longitudinal displacement and velocity calculations, the signal emitter 20 emits the signals at a frequency of at least 800 Hz and, more preferably, above 1200 Hz, and, even more preferably, above 1800 Hz and with a wavelength below 2 mm and, more preferably, below 1 mm. By having the accurate calculations of the longitudinal pile displacement and velocity of longitudinal displacement at various times during and following the impact of the ram 16 of the pile driver 18 on the end of the pile 12, combined with the known material properties of the pile 12, the driving stresses and forces on the pile and the resisting stresses from the pile and ground can be readily computed using formulas readily available to pile testing practitioners. This allows the load bearing capacity of the pile 12 to be more accurately estimated without the safety risks and other disadvantages associated with manual measurement of the longitudinal displacement and the use of accelerometers and strain gauge transducers mounted to the pile 12.

From the foregoing, it will be seen that this invention is one well adapted to attain all the ends and objectives hereinabove set forth together with other advantages that are inherent to the structure.

It will be understood that certain features and subcombinations are of utility and may be employed without reference to other features and subcombinations. This is contemplated by and is within the scope of the invention.

Since many possible embodiments may be made of the invention without departing from the scope thereof, it is to be understood that all matter herein set forth or shown in the accompanying drawings is to be interpreted as illustrative and not in a limiting sense.

What is claimed is:

1. A method of calculating a longitudinal displacement and a velocity of the longitudinal displacement of a load bearing pile as the pile is being driven into the soil, said method comprising the steps of:
emitting a series of signals at a preselected frequency from a signal emitter in a direction toward the pile as the pile is being driven longitudinally into the soil;
reflecting said series of signals from a reflector coupled with said pile toward a sensor positioned for receiving said reflected series of signals;
receiving said reflected series of signals at said sensor; and
calculating the longitudinal displacement and the velocity of said longitudinal displacement of the pile using said reflected series of signals received at said sensor and said preselected frequency at which said series of signals are emitted from said signal emitter.

2. The method of claim 1, wherein said series of signals is a series of electromagnetic waves.

3. The method of claim 1, wherein said signal emitter is a laser.

4. The method of claim 1, wherein said reflector is mounted at a fixed position on said pile at an elevation above said signal emitter and said sensor.

5. The method of claim 1, wherein said series of signals are emitted at a frequency above 800 Hz.

6. The method of claim 1, including the step of transmitting said reflected series of signals received at said sensor and said preselected frequency at which said series of signals are emitted from said signal emitter to a computing device to perform said step of calculating said longitudinal displacement and the velocity of said longitudinal displacement.

7. The method of claim 1, wherein said signal emitter is a laser and said reflective position is a reflector mounted at a fixed position on said pile.

8. The method of claim 7, wherein said series of signals are emitted at a frequency above 800 Hz.

9. The method of claim 8, including the step of transmitting said reflected series of signals received at said sensor and said preselected frequency at which said series of signals are emitted from said signal emitter to a computing device to perform said step of calculating said longitudinal displacement and the velocity of said longitudinal displacement.

10. A system for calculating a longitudinal displacement and a velocity of the longitudinal displacement of a load bearing pile as the pile is being driven into the soil, said system comprising:
a signal emitter for emitting a series of signals at a preselected frequency in a direction toward the pile as the pile is being driven longitudinally into the soil;
a reflector mounted at a fixed position associated with said pile for reflecting said series of signals from said signal emitter;
a sensor positioned for receiving said reflected series of signals; and
a computing device operably coupled with said signal emitter and said sensor for calculating the longitudinal displacement and the velocity of said longitudinal displacement of the pile using said reflected series of signals received at said sensor and said preselected frequency at which said series of signals are emitted from said signal emitter.

11. The system of claim 10, wherein said signal emitter is operable to emit a series of electromagnetic waves.

12. The system of claim 10, wherein said signal emitter is a laser.

13. The system of claim 10, wherein said signal emitter is operable to emit said series of signals at a frequency above 800 Hz.

14. The system of claim 10, wherein said signal emitter is a laser operable to emit said series of signals at a frequency above 800 Hz.

15. A method of calculating a longitudinal displacement and a velocity of the longitudinal displacement of a load bearing pile as the pile is being driven into the soil, said method comprising the steps of:
emitting a series of signals comprising electromagnetic waves at a frequency above 800 Hz from a signal emitter in a direction toward the pile as the pile is being driven longitudinally into the soil;
reflecting said series of signals from a reflector mounted at a fixed position on said pile toward a sensor positioned for receiving said reflected series of signals;
receiving said reflected series of signals at said sensor; and
transmitting said reflected series of signals received at said sensor and said preselected frequency at which said series of signals are emitted from said signal emitter to a computing device where said longitudinal displacement and the velocity of said longitudinal displacement are calculated.

16. The method of claim 15, wherein said signal emitter is a laser.

17. The method of claim 15, including the step of displaying in a visually readable form the calculated longitudinal displacement and the velocity of said longitudinal displacement.

18. The method of claim 15, wherein said direction is vertical or a preselected angle from the vertical.

19. The method of claim 15, wherein the series of signals comprising electromagnetic waves having a wavelength less than 2 mm.

20. The method of claim 15, wherein said electromagnetic waves are emitted at a frequency above 1800 Hz.
